(19) United States
(12) Patent Application Publication
(10) Pub. No.: US 2009/0282250 A1
(43) Pub. Date: Nov. 12, 2009

(54) COMMUNICATION APPARATUS, SERVER, AND COMPUTER PROGRAM PRODUCT THEREFOR

(75) Inventors: Hideaki SATO, Kanagawa (JP); Tatsuyuki Matsushita, Tokyo (JP); Kentaro Umesawa, Kanagawa (JP); Hideki Matsumoto, Kanagawa (JP); Ryuiti Koike, Tokyo (JP); Taku Kato, Kanagawa (JP); Haruhiko Toyama, Kanagawa (JP); Satoshi Ito, Tokyo (JP); Toru Kambayashi, Kanagawa (JP)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignee: Kabushiki Kaisha Toshiba

(21) Appl. No.: 12/329,375

(22) Filed: Dec. 5, 2008

(30) Foreign Application Priority Data
May 8, 2008 (JP) 2008-122177

(51) Int. Cl. H04L 9/00

(52) U.S. Cl. 713/171

(57) ABSTRACT

A communication apparatus receives, from another communication apparatus, a plurality of encrypted pieces obtained by encrypting a plurality of pieces constituting a part of a content and obtains a part or all of decryption keys used for decrypting the encrypted pieces. The communication apparatus also obtains an invalid piece list showing one or more identifiers of one or more encrypted pieces that can respectively be decrypted by using one or more decryption keys that have already been invalidated. In the case where at least one of the encrypted pieces is listed in the invalid piece list, the communication apparatus deletes the at least one of the encrypted pieces, based on an obtainment status of the encrypted pieces or an obtainment status of the decryption keys.

### CROSS-REFERENCE TO RELATED APPLICATIONS

This application is based upon and claims the benefit of priority from the prior Japanese Patent Application No. 2008-122177, filed on May 8, 2008; the entire contents of which are incorporated herein by reference.

### BACKGROUND OF THE INVENTION

1. Field of the Invention

The present invention relates to a communication apparatus that receives an encrypted content encrypted with an encryption key from another communication apparatus, a server that transmits a decryption key used for decrypting the encrypted content, and a computer program product therefor.

2. Description of the Related Art

Generally speaking, systems used for distributing contents include “single server” systems and “distributed server” systems. In a single-server system, for example, one content server is connected to a license server and clients via a network so that a content is distributed from the content server to each of the clients. The distributed content is encrypted, and key information related to the encryption process is stored in the license server. The content server stores the content therein as E(KT) [C]. In this expression, “KT” is a key called a title key, whereas “C” is a content in plain text. E(KT) [C] means that “C” is encrypted with “KT”. The key information contains “KT”. A client B obtains the key information from the license server, encrypts the key information with a key KB that is unique to the client (i.e., the client B), and stores therein the encrypted key information in correspondence with the content E(KT) [C] that has been received from the content server. After that, the client B decrypts the key information with the key KB, takes out the title key KT, and decrypts the content E(KT) [C] with the title key KT. Thus, the client B is able to use the content.

In this configuration, when the client B downloads the content E(KT) [C] from the content server, the client B and the content server perform an authentication process and a key exchange process with each other. As a result, the client B shares a temporary key KtmpB. The content server encrypts the content E(KT) [C] with the temporary key KtmpB and transmits a content E(KtmpB) [E(KT) [C]] to the client B. The client B decrypts the content E(KtmpB) [E(KT) [C]] with the temporary key KtmpB that the client B shares with the content server as a result of the authentication and the key exchange processes described above and takes out E(KT) [C]. In this configuration, even if the encrypted content E(KtmpB) [E(KT) [C]] is illegitimately read on a path in the network, it is not possible to decrypt the illegitimately read content unless the temporary key KtmpB is available. In other words, the content is encrypted with the temporary key that is different for each of the clients, so that the content is individualized for each of the clients. As a result, it is possible to inhibit illegitimate use of the content. For example, by configuring a temporary key KtmpA for a client A and the temporary key KtmpB for the client B so as to be different from each other, a content E(KtmpA) [E(KT) [C]] distributed to the client A and the content E(KtmpB) [E(KT) [C]] distributed to the client B are mutually different individual pieces of data. By individualizing the content with the mutually different encryption keys in this manner, it is possible to inhibit illegitimate use of the content.

In a single-server system, however, because the communication is performed between each of the clients and the content server in a one-to-one manner, when a large number of clients try to receive the distribution of a content from the content server, a problem arises where the level of distribution efficiency is lowered.

On the other hand, examples of the distributed-server systems include a content distribution system called BitTorrent that uses a peer-to-peer (P2P) network (see, for example, BitTorrent Protocol Specification v. 1.0). In this system, a tracker that is different for each of the contents, a seeder, and a leecher are connect to one another by using the P2P network. Also, each of the distributed contents is divided into a plurality of pieces. The seeder is a node that distributes the pieces constituting a content for the purpose of distributing (i.e., uploading) the content. The leecher is a node that receives the pieces constituting the content and distributes the pieces constituting the content for the purpose of receiving (i.e., downloading) the content. In other words, a leecher may become a seeder when the leecher has obtained a certain number of pieces that constitute the content. Thus, some of the seeders have become a seeder after a leecher has received a part or all of the pieces that constitute a content, and other seeders are each a seeder (from the beginning) that is provided on the system side (in advance or during a distribution). The latter type of seeders will be referred to as initial seeders. An initial seeder stores therein a part or all of the pieces that constitute one content. In the explanation below, a “seeder” denotes either a seeder or an initial seeder, unless stated otherwise. A node denotes one of a leecher, a seeder, and an initial seeder. A tracker stores therein node information related to each of the nodes. When a leecher has accessed the tracker, the tracker provides the node information for the leecher.

In this configuration, when a leecher is to receive a distribution of a content, the leecher first obtains information called a Torrent File. The Torrent File is, for example, given from a server (hereinafter, a “sales server”) offering a service of selling contents to content providers or users, to another node or another sales server, and is further given by said another node or said another sales server to a leecher. Alternatively, another arrangement is acceptable in which the Torrent File is recorded on a recording medium like a Compact Disk Read-Only Memory (CD-ROM) and distributed offline to a leecher. The Torrent File stores therein tracker information related to the content and file information of the content. The tracker information contains a connection destination of the tracker. The file information contains, for example, hash information of the pieces that constitute the content. The hash information is used for checking the completeness of the pieces. In other words, the hash information is used for calculating hash values of the pieces downloaded by the leecher, comparing the calculated hash values with hash values of the pieces, and checking to see if the received pieces have not been tampered.

When having obtained the Torrent File, the leecher connects to the tracker based on the tracker information. The tracker transmits the node information described above to the leecher. The node information contains a list of connection destinations of one or more nodes. The leecher connects to a plurality of nodes, based on the node information. As for the pieces distributed by the nodes, it is often the case that the pieces are mutually different for each of the nodes. Because the leecher is able to receive the mutually different pieces from the plurality of nodes, the leecher is able to receive the content at a high speed.

As explained above, in such a content distribution system that uses a P2P network, the content is stored as being distributed in the plurality of nodes. Thus, in such a system, even if a large number of nodes try to receive the distribution of the content, each of the node is able to receive the distribution of the content from the plurality of other nodes via the P2P network. Thus, P2P content distribution systems have a higher level of distribution efficiency than single-server systems.

In a content distribution system as described above where it is possible to distribute a content through a plurality of nodes, it is also desirable to protect the distributed content with an encryption process so that it is possible to inhibit illegitimate use of the content. In such a content distribution system, however, a content that is received by mutually different leechers from a seeder must be the same for all the leechers even after the content has been encrypted, unlike in a single-server system. Thus, it is difficult to distribute an individually encrypted content to each of the leechers. Consequently, if one key that is used for decrypting the encrypted content is disclosed, there is a possibility that it may become possible to decrypt all of the large number contents that are present in the network.

On the other hand, U.S. Publication Pat. No. 3,917,395 discloses a content distributing method by which a content is divided into a plurality of pieces and, for each of the pieces, a plurality of encrypted pieces are generated by encrypting the piece with a plurality of encryption keys.

The content distributing method disclosed in U.S. Publication Pat. No. 3,917,395 requires that each of the users who are to receive the distribution of the content should obtain all the encrypted pieces. Thus, when this content distributing method is applied to a P2P content distribution system without any modification, there is a possibility that the level of distribution efficiency may be lowered. Further, even if there are a plurality of keys used for decrypting the encrypted content, if the keys are disclosed, there is a possibility that it may become possible to decrypt the content without having to legitimately obtain the decryption keys.

### SUMMARY OF THE INVENTION

According to one aspect of the present invention, a communication apparatus includes a receiving unit that receives, from at least another communication apparatus, a plurality of encrypted pieces obtained by encrypting a plurality of pieces that constitute a part of a content by using mutually different encryption keys; a memory to store the encrypted pieces received by the receiving unit, with corresponding identifiers; a key obtaining unit that obtains a part or all of decryption keys used for decrypting the encrypted pieces; a list obtaining unit that obtains an invalid piece list showing one or more identifiers of one or more encrypted pieces that have already been invalidated; and a deleting unit that deletes at least one of the encrypted pieces from the memory according to an obtainment status of the encrypted pieces or an obtainment status of the decryption keys, when the at least one of the encrypted pieces is listed in the invalid piece list.

According to another aspect of the present invention, a communication apparatus includes a receiving unit that receives, from at least another communication apparatus, a plurality of encrypted pieces obtained by encrypting a plurality of pieces that constitute a part of a content by using mutually different encryption keys; a key obtaining unit that obtains a part or all of the decryption keys used for decrypting the encrypted pieces; and a list obtaining unit that obtains an invalid piece list showing one or more identifiers of one or more encrypted pieces that have already been invalidated, wherein the receiving unit requests an encrypted piece that is not listed in the invalid piece list from the at least another communication apparatus and receives the requested encrypted piece from the at least another communication apparatus.

According to still another aspect of the present invention, a server includes a receiving unit that receives a request message for requesting decryption keys used for decrypting a plurality of encrypted pieces from a communication apparatus that receives the encrypted pieces from at least another communication apparatus, the encrypted pieces being obtained by encrypting a plurality of pieces that constitute a part of a content by using mutually different encryption keys; a first storage unit that stores the decryption keys; a list obtaining unit that obtains an invalid piece list showing one or more identifiers of one or more encrypted pieces that have already been invalidated; a determining unit that determines whether the decryption keys are transmitted, according to whether any of the encrypted pieces that can respectively be decrypted by using the decryption keys requested in the request message is listed in the invalid piece list; and a key transmitting unit that reads the decryption keys requested in the request message from the first storage unit and transmits the read decryption keys to the communication apparatus, when the determining unit has determined that the decryption keys are transmitted.

According to still another aspect of the present invention, a computer program product having a computer readable medium including programmed instructions, wherein the instructions, when executed by a computer, cause the computer to perform: receiving, from at least another communication apparatus, a plurality of encrypted pieces obtained by encrypting a plurality of pieces that constitute a part of a content by using mutually different encryption keys; storing the encrypted pieces received by the receiving unit, with corresponding identifiers; obtaining a part or all of decryption keys used for decrypting the encrypted pieces;

obtaining an invalid piece list showing one or more identifiers of one or more encrypted pieces that have already been invalidated; and deleting at least one of the encrypted pieces from the memory according to an obtainment status of the encrypted pieces or an obtainment status of the decryption keys, when the at least one of the encrypted pieces is listed in the invalid piece list.

According to still another aspect of the present invention, a computer program product having a computer readable medium including programmed instructions, wherein the instructions, when executed by a computer, cause the computer to perform: receiving a request message for requesting decryption keys used for decrypting a plurality of encrypted pieces from a communication apparatus that receives the encrypted pieces from at least another communication apparatus, the encrypted pieces being obtained by encrypting a plurality of pieces that constitute a part of a content by using mutually different encryption keys; obtaining an invalid piece list showing one or more identifiers of one or more encrypted pieces that have already been invalidated; determining whether the decryption keys are transmitted, according to whether any of the encrypted pieces that can respectively be decrypted by using the decryption keys requested in the request message is listed in the invalid piece list; and reading the decryption keys requested in the request message from a storage unit, when it has been determined that the decryption keys are transmitted, and transmitting the read decryption keys to the communication apparatus.

### BRIEF DESCRIPTION OF THE DRAWINGS

FIG. 1 is a block diagram of a content distribution system according to an exemplary embodiment of the present invention;

FIG. 2 is a schematic drawing for explaining how a content is divided into a plurality of pieces;

FIG. 3 is a schematic diagram illustrating encrypted pieces;

FIG. 4 is a diagram illustrating an example of encrypted pieces stored in a seeder 52A;

FIG. 5 is a diagram illustrating another example of the encrypted pieces stored in the seeder 52A;

FIG. 6 is a diagram illustrating yet another example of the encrypted pieces stored in the seeder 52A;

FIG. 7 is a diagram illustrating an example of a data structure of piece information;

FIG. 8 is an exemplary functional diagram of a leecher 50;

FIG. 9 is a diagram illustrating an example of a Torrent File;

FIG. 10 is an exemplary functional diagram of a key server 53;

FIG. 11 is a diagram illustrating an example of a data structure of node information;

FIGS. 12A and 12B are flowcharts of a procedure in a content distributing process;

FIG. 13 is a flowchart of a procedure in a comparing process;

FIG. 14 is a flowchart of a procedure in an invalid encrypted piece deleting process and a substitute encrypted piece obtaining process according to a modification example of the embodiment; and

FIG. 15 is a flowchart of a procedure in a comparing process according to a modification example of the embodiment.

### DETAILED DESCRIPTION OF THE INVENTION

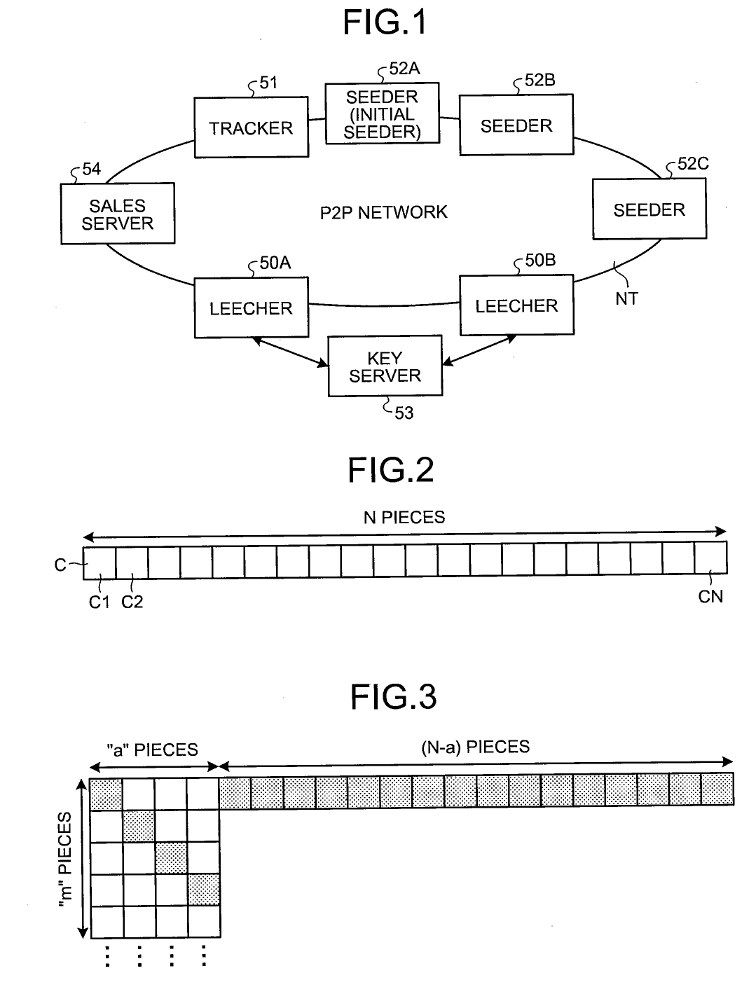

FIG. 1 is a block diagram of a content distribution system according to an exemplary embodiment of the present invention. In the content distribution system according to the present embodiment, leechers 50A, 50B, a tracker 51, seeders 52A, 52B, 52C, and a sales server 54 are connected together via a P2P network NT. Each of the leechers 50A and 50B is connected to the key server 53 via a network like the Internet (not shown). In this situation, each of the leechers 50A and 50B and the seeders 52A, 52B, and 52C is a node. Each of the seeders 52A, 52B, and 52C stores therein encrypted pieces obtained by encrypting a plurality of pieces into which a content has been divided, with mutually different encryption keys. In the following explanation, a content that is constituted with such encrypted pieces will be referred to as an encrypted content. The details of such an encrypted content will be explained later. Of the seeders 52A, 52B, and 52C, the seeder 52A functions as an initial seeder, which is explained above. The seeder 52A stores therein all of the encrypted pieces that have been generated by encrypting each of the pieces constituting the one content by using a plurality of encryption keys per piece. The tracker 51 stores therein node information used for accessing each of the nodes. The key server 53 stores therein decryption keys used for decrypting the encrypted pieces. The sales server 54 stores therein a Torrent File.

The leecher 50A receives the Torrent File from the sales server 54, obtains the node information by accessing the tracker 51 based on the Torrent File, receives the decrypted pieces by accessing at least one of the seeders 52A, 52B, 52C, and the leecher 50B based on the obtained node information, obtains all the encrypted pieces corresponding to the pieces, and receives a key-ring containing the decryption keys that are respectively used for decrypting the encrypted pieces from the key server 53. The leecher 50B also performs the same processes. In the following explanation, in the case where the leechers 50A and 50B do not need to be distinguished from each other, each of them will be simply referred to as the leecher 50. Similarly, in the case where the seeders 52A, 52B, and 52C do not need to be distinguished from one another, each of them will be simply referred to as the seeder 52.

Next, a configuration of the content will be explained. The content is any of various types of digital data such as moving-picture data and audio data like Moving Picture Experts Group (MPEG) 2 and MPEG 4 as well as text data and still image data. Also, data that is obtained by encrypting such digital data will be also referred to as a content. For example, data that is obtained by encrypting a High Definition Digital Versatile Disk (HD DVD) prepared video content according to the Advanced Access Content System (AACS) specifications can also serve as a content. In the following explanation, the entire content will be identified as “C”. The content “C” may be in plain text or encrypted. FIG. 2 is a schematic drawing for explaining how the content is divided into a plurality of pieces. For example, one content (i.e., the content C in the present example) is divided into as many pieces as N (N>1), the pieces being identified as C1 to CN. The data lengths of the pieces C1, C2, . . . , CN may all be equal or may be different from one another. The pieces C1 to CN, the quantity of which is equal to “N”, are encrypted with mutually different encryption keys. In this situation, of the N pieces, each of as many pieces as “a” is encrypted by using as many mutually different encryption keys as “m” per piece. Each of the remaining pieces, the quantity of which is equal to “N-a”, is encrypted by using one encryption key per piece. In other words, as for each of some of the pieces the quantity of which is equal to “a”, the piece is encrypted with the mutually different encryption keys the quantity of which is equal to “m”, so that the mutually different pieces (i.e., the encrypted pieces) the quantity of which is equal to “m” are generated. As for each of the other pieces the quantity of which is equal to “N-a”, the piece is encrypted with the one encryption key so that the one encrypted piece is generated for the one piece. FIG. 3 is a schematic diagram illustrating the encrypted pieces. It is possible to individualize the entire encrypted content that is constituted with as many encrypted pieces as “N”, by differentiating the combination of encrypted pieces that is obtained by selecting one out of as many encrypted pieces as “m” for each of the pieces the quantity of which is equal to “a”.

Next, a hardware configuration of each of the apparatuses such as the leecher 50, the tracker 51, the seeder 52, and the key server 53 will be explained. Each of the apparatuses includes: a controlling device such as a Central Processing Unit (CPU) that exercises the overall control of the apparatus; storage devices such as a Read-Only Memory (ROM) and a Random Access Memory (RAM) that store therein various types of data and various types of computer programs (hereinafter, “programs”); external storage devices such as a Hard Disk Drive (HDD) and a Compact Disk (CD) drive device that store therein various types of data and various types of programs; and a bus that connects these constituent elements to one another. Each of the apparatuses has a hardware configuration to which a commonly-used computer can be applied. In addition, a display device that displays information, input devices such as a keyboard and a mouse that receive inputs of instructions from the user, and a communication interface (I/F) that controls communication with external apparatuses are connected to each of the apparatuses in a wired or wireless manner.

Next, a functional configuration of the seeder 52 will be explained. The seeder 52 stores therein the encrypted pieces that have been obtained by encrypting the plurality of pieces C1 to CN constituting the content C, in correspondence with indexes (i.e., suffixes) of the decryption keys that are used for decrypting the pieces C1 to CN, respectively. The decryption keys may be the same as the encryption keys or may be different from the encryption keys. In either situation, because the pieces C1 to CN have been encrypted with the encryption keys respectively, it is possible to identify each of the encrypted pieces by using the index of the corresponding one of the decryption keys used for decrypting the encrypted piece. These encrypted pieces are stored in, for example, an external storage device.

To simplify the explanation in the following sections, it is assumed that the encryption keys are identical to the decryption keys, respectively. In the case where the index of each decryption key is expressed as (i, j), and the decryption key is expressed as K(i, j), each encrypted piece can be expressed as below, for example:

E(K(i, j)) [Cj]

where i and j are integers that satisfy 1≦i≦m and 1≦j≦N (m>1); With regard to mutually different indexes (i, j) and (i′, j′) where (i, j)≠(i′, j′), K(i, j)=K(i′, j′) may be satisfied.

The encrypted content that is constituted with the encrypted pieces can be expressed as below, for example:

{E(K(i1, 1)) [C1], E(K(i2, 2)) [C2], . . . , E(K(iN, N)) [CN]}

where 1≦i1, . . . , iN≦m is satisfied.

The sequence of the encrypted pieces in the encrypted content is expressed with the combination of the indexes of the encrypted pieces and can be expressed as below, for example (In the example below, the indexes corresponding to the pieces C1 to CN are arranged in a row from the left side):

{(i1, 1), (i2, 2), . . . , (iN, N)}

where 1≦i1, . . . , iN≦m is satisfied.

Accordingly, what is stored in the seeder 52 while keeping the encrypted pieces in correspondence with the indexes can be expressed as below, for example:

{(E(K(i1, 1)) [C1], (i1, 1)), E(K(i2, 2)) [C2], (i2, 2)), . . . , E(K(iN, N)) [CN], (iN, N))}

where 1≦i1, . . . , iN≦m is satisfied.

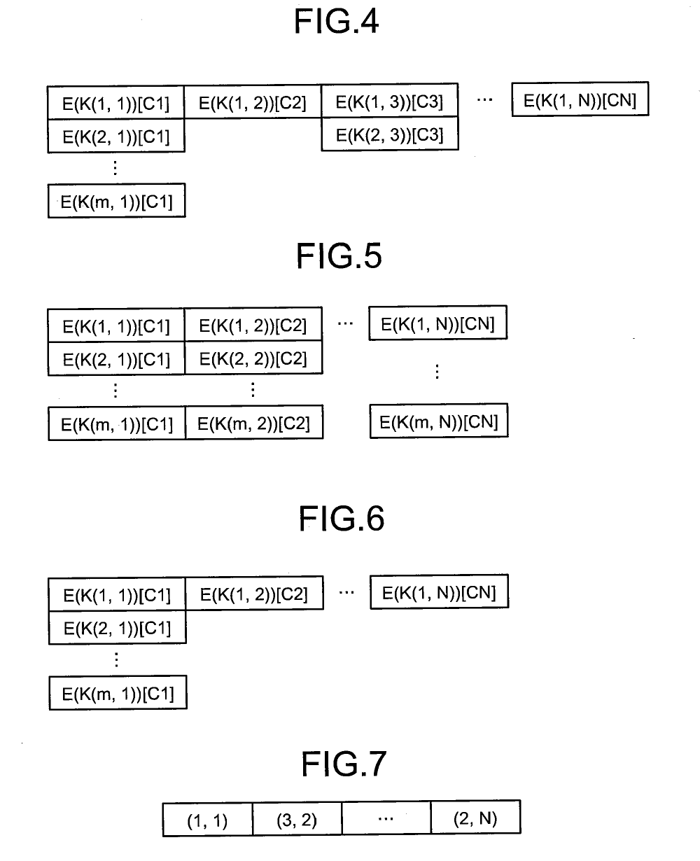

Further, the seeder 52A, which is an initial seeder, stores therein all the encrypted pieces that have been generated by encrypting each of the encrypted pieces that respectively correspond to the pieces constituting the content, by using the plurality of encryption keys per piece. FIG. 4 is a diagram illustrating an example of the encrypted pieces stored in the seeder 52A. In FIG. 4, it is indicated that, of the N pieces, each of as many pieces as “a” (where 1<a<N) is encrypted by using the plurality of mutually different encryption keys per piece. In the example shown in FIG. 4, the number of encryption keys used for encrypting each piece is different for the different pieces. The number of encryption keys used for encrypting the piece C1 is m, whereas the number of encryption keys used for encrypting the piece C3 is two. According to the present embodiment, however, another arrangement is acceptable in which the number of encryption keys used for encrypting each piece is the same for all of the pieces. In a piece processing apparatus, with this arrangement where, of the N pieces, each of as many pieces as “a” (where 1<a<N) is encrypted by using the plurality of mutually different encryption keys per piece, it is possible to have a configuration so that, for example, the higher the level of importance is, the larger the number of encryption keys is.

The present embodiment is not limited to the example described above. For example, another arrangement is acceptable in which “a=N” is satisfied as shown in FIG. 5, so that each of all the N pieces is encrypted by using as many mutually different encryption keys as “m” per piece. With this arrangement, it is possible to increase the number of variations of the sequence of the encrypted pieces. Further, yet another arrangement is acceptable in which “a=1” is satisfied as shown in FIG. 6, so that only one of the N pieces is encrypted with as many mutually different encryption keys as “m”. With this arrangement, it is possible to improve the level of distribution efficiency.

In the configuration as described above, when being accessed by the leecher 50, the seeder 52 transmits piece information to the leecher 50, the piece information indicating the sequence of the encrypted pieces stored in the seeder 52. FIG. 7 is a diagram illustrating an example of a data structure of the piece information. In FIG. 7, it is indicated that the encrypted piece corresponding to the piece C1 is to be decrypted with a decryption key K(1, 1), whereas the encrypted piece corresponding to the piece C2 is to be decrypted with a decryption key K(3, 2). In other words, the piece information indicates the correspondence relationship between the encrypted pieces and the decryption keys each of which is used for decrypting a different one of the encrypted pieces. When having been requested by the leecher 50 to distribute an encrypted piece based on the piece information, the seeder 52 judges whether the requested encrypted piece is stored therein. In the case where the result of the judging process is in the affirmative, the seeder 52 transmits the requested encrypted piece to the leecher 50.

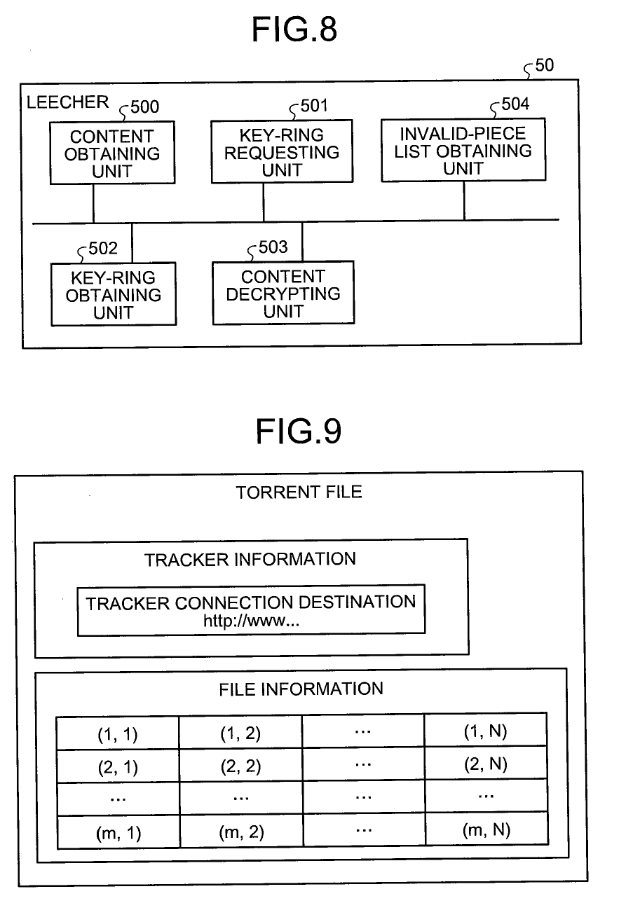

Next, various types of functions that are realized in the hardware configuration described above when the CPU of the leecher 50 executes the various types of programs stored in the storage devices and the external storage devices will be explained. FIG. 8 is an exemplary functional diagram of the leecher 50. The leecher 50 includes a content obtaining unit 500, a key-ring requesting unit 501, a key-ring obtaining unit 502, a content decrypting unit 503, and an invalid-piece list obtaining unit 504. The actual substance of each of these constituent elements is generated in a storage device (e.g., the RAM) when the CPU executes the programs.

The content obtaining unit 500 receives the encrypted pieces that constitute the encrypted content from at least one of the seeders 52, via the P2P network NT and stores the received encrypted pieces into a storage device like the RAM or an external storage device. More specifically, the content obtaining unit 500 first receives a Torrent File from the sales server 54. The Torrent File contains tracker information including tracker connection destination information used for connecting to the tracker 51 and file information indicating what encrypted pieces constitute the encrypted content. FIG. 9 is a diagram illustrating an example of the Torrent File. In FIG. 9, as for the file information, the indexes corresponding to the encrypted pieces are shown as the information used for identifying each of the encrypted pieces.

Based on the Torrent File, the content obtaining unit 500 accesses the tracker 51 via the P2P network NT and receives, from the tracker 51, node information used for accessing the other nodes (e.g., the seeders 52 and other leechers 50) connected to the P2P network NT. (The node information will be explained in detail later.) After that, based on the node information, the content obtaining unit 500 accesses at least one of the nodes and obtains piece information indicating the sequence of encrypted pieces stored in the node. Based on the piece information, the content obtaining unit 500 then receives the encrypted pieces that constitute the encrypted content from at least one of the nodes so as to obtain all the encrypted pieces (hereinafter, the “piece sequence”) that constitute the encrypted content. For example, of the encrypted pieces shown in FIG. 3, the content obtaining unit 500 obtains all the encrypted pieces that are shown with hatching as the piece sequence.

Also, the content obtaining unit 500 refers to an invalid piece list that has been obtained by the invalid-piece list obtaining unit 504 (explained below) and judges whether each of the obtained encrypted pieces is an encrypted piece that is invalid (hereinafter, “invalid encrypted piece”). In the case where the content obtaining unit 500 has judged that any of the obtained encrypted pieces is an invalid encrypted piece, the content obtaining unit 500 deletes the encrypted piece from the storage device or the external storage device and obtains another encrypted piece (hereinafter, a “substitute encrypted piece”) that serves as a substitute for the deleted encrypted piece. More specifically, the substitute encrypted piece is an encrypted piece from which the same piece can be decrypted as from the encrypted piece that has been judged to be an invalid encrypted piece, by using a decryption key that is different from the decryption key used for decrypting the judged encrypted piece.

The invalid-piece list obtaining unit 504 obtains the invalid piece list from the tracker 51. The invalid piece list shows one or more identifiers of one or more encrypted pieces that can respectively be decrypted by using one or more decryption keys that have been disclosed and have already been invalidated. For the sake of convenience of the explanation, the encrypted pieces listed in the invalid piece list will be referred to as invalid encrypted pieces. The identifiers of the encrypted pieces listed in the invalid piece list can be in any form as long as the identifiers make it possible to identify each of the encrypted pieces. Each of the identifiers may be, for example, a hash value of a corresponding one of the encrypted pieces. More specifically, for example, the invalid piece list shows, for each of the encrypted pieces that can respectively be decrypted with the decryption keys that have already been invalidated, the index of the piece and a hash value of the encrypted piece. For example, each of the hash values of the encrypted pieces can be expressed as below:

{hash(E(K(i, j)) [Cj])}

where 1≦i≦m and 1≦j≦N are satisfied.

Each of such encrypted pieces of which the hash value is listed in the invalid piece list is judged to be an invalid encrypted piece.

The key-ring requesting unit 501 transmits a request message to the key server 53 to request a key-ring used for decrypting the piece sequence. The key-ring contains the decryption keys used for decrypting the encrypted pieces in the piece sequence in correspondence with the sequence of the encrypted pieces. The key-ring and the decryption keys will be explained in detail later. The request message contains index information as information that specifies the sequence of the decryption keys contained in the key-ring, the index information indicating the combination (i.e., the sequence) of the indexes of the encrypted pieces in the piece sequence.

For example, the sequence can be expressed as below:

{(i1, 1), (i2, 2), . . . , (iN, N)}

where 1≦i1, . . . , iN≦m is satisfied.

The key-ring obtaining unit 502 receives the key-ring that has been transmitted from the key server 53 in response to the request message. The content decrypting unit 503 decrypts the encrypted pieces that have been obtained by the content obtaining unit 500, with the decryption keys that are contained in the key-ring obtained by the key-ring obtaining unit 502 and that correspond to the encrypted pieces respectively. The content decrypting unit 503 thus obtains the content that is constituted with the pieces resulting from the decryption process.

There is a situation in which the leecher 50 functions as a seeder, as explained above; however, because the functional configuration of a seeder has already been explained in the description of the seeder 52, the explanation thereof will be omitted.

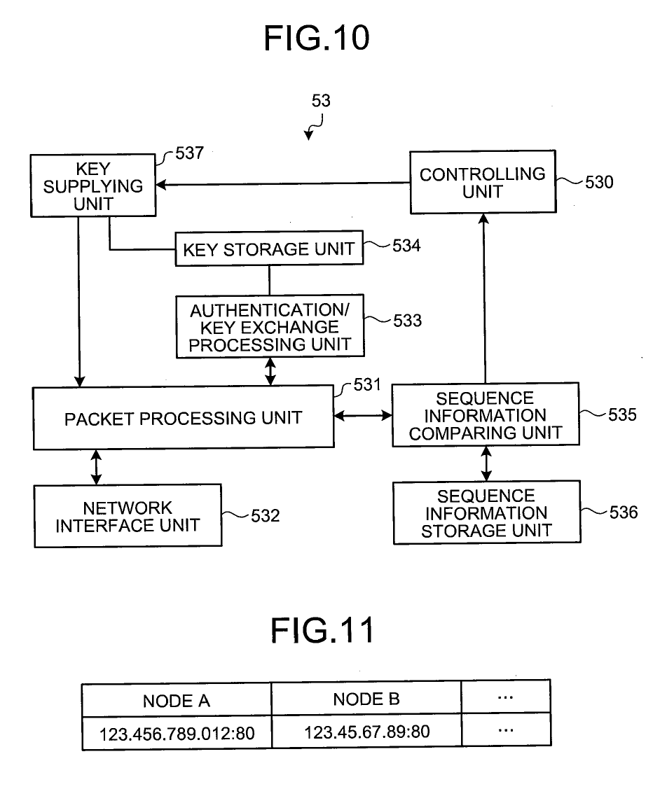

Next, various types of functions that are realized when the CPU of the key server 53 executes the various types of programs stored in the storage devices and the external storage devices will be explained. FIG. 10 is an exemplary functional diagram of the key server 53. The key server 53 includes a controlling unit 530, a packet processing unit 531, a network interface unit 532, an authentication/key exchange processing unit 533, a key storage unit 534, a sequence information storage unit 536, a sequence information comparing unit 535, and a key supplying unit 537. The actual substance of each of the units such as the controlling unit 530, the sequence information comparing unit 535, the network interface unit 532, the packet processing unit 531, the authentication/key exchange processing unit 533, and the key supplying unit 537 is generated in a storage device (e.g., the RAM) when the CPU executes the programs. The key storage unit 534 is, for example, stored in an external storage device.

The controlling unit 530 controls the entirety of the key server 53 and also intermediates instructions from the sequence information comparing unit 535 to the key supplying unit 537. The packet processing unit 531 packetizes various types of data to be transmitted to external apparatuses such as a leecher 50 and forwards the packet to the network interface unit 532. The packet processing unit 531 also obtains data, based on packets forwarded from the network interface unit 532. The network interface unit 532 controls communication with external apparatuses, transmits the packetized data forwarded from the packet processing unit 531 to the external apparatuses, and forwards the packets received from the external apparatuses to the packet processing unit 531.

The authentication/key exchange processing unit 533 performs a mutual authentication process with the leecher 50 via the network interface unit 532 and, after the authentication process has been finished, receives the index information from the leecher 50.

The key storage unit 534 is provided in, for example, an external storage device such as an HDD and stores therein the decryption keys used for decrypting the encrypted pieces. Each of the decryption keys is expressed as, for example, K(i, j), as explained above.

The sequence information storage unit 536 is provided in, for example, an external storage device such as an HDD and stores therein sequence information indicating the sequences that respectively correspond to all the key-rings that were transmitted to the leechers 50 in the past. For example, the sequences that respectively correspond to the key-rings can be expressed as below, like the sequences indicated in the index information described above:

{(i1, 1), (i2, 2), . . . , (iN, N)}

where 1≦i1, . . . , iN≦m is satisfied.

The sequence information comparing unit 535 compares the sequence information stored in the sequence information storage unit 536 with the index information received from the leecher 50 and determines whether the key-ring corresponding to the sequence indicated in the index information should be transmitted. More specifically, in the case where the sequence information storage unit 536 stores therein no sequence information indicating the same sequence as the sequence indicated in the index information, the sequence information comparing unit 535 determines that the key-ring corresponding to the sequence indicated in the index information should be transmitted. For example, the key-ring can be expressed as below (In the example below, the decryption keys that respectively correspond to the pieces C1 to CN are arranged in a row from the left side):

{K(i1, 1), K(i2, 2), . . . , K(iN, N)}

where 1≦i1, . . . , iN≦m is satisfied.

In the case where the sequence information comparing unit 535 has determined that the key-ring should be transmitted, the sequence information comparing unit 535 instructs, via the controlling unit 530, the key supplying unit 537 to transmit the key-ring to the leecher 50. On the contrary, in the case where the sequence information comparing unit 535 has determined that the key-ring should not be transmitted, the sequence information comparing unit 535 instructs, via the controlling unit 530, the key supplying unit 537 that the transmission of the key-ring to the leecher 50 is prohibited.

According to the instruction received from the sequence information comparing unit 535 via the controlling unit 530 instructing that the key-ring should be transmitted, the key supplying unit 537 reads the decryption keys that correspond to the sequence of the key-ring out of the key storage unit 534 and transmits the key-ring that contains the read decryption keys to the leecher 50 via the network interface unit 532.

Next, a configuration of the tracker 51 will be explained. When being accessed by the leecher 50, the tracker 51 transmits the node information to the leecher 50, the node information being used for accessing the nodes connected to the P2P network NT. The node information contains sets each made up of an IP address and a port number of a different one of the nodes. FIG. 11 is a diagram illustrating an example of a data structure of the node information. In FIG. 11, each of the nodes A and B is any one of the leechers 50A and 50B and the seeders 52A, 52B, and 52C, and a set made up of the IP address and the port number is shown for each of the nodes. Also, the tracker 51 transmits the invalid piece list explained above to the leecher 50.

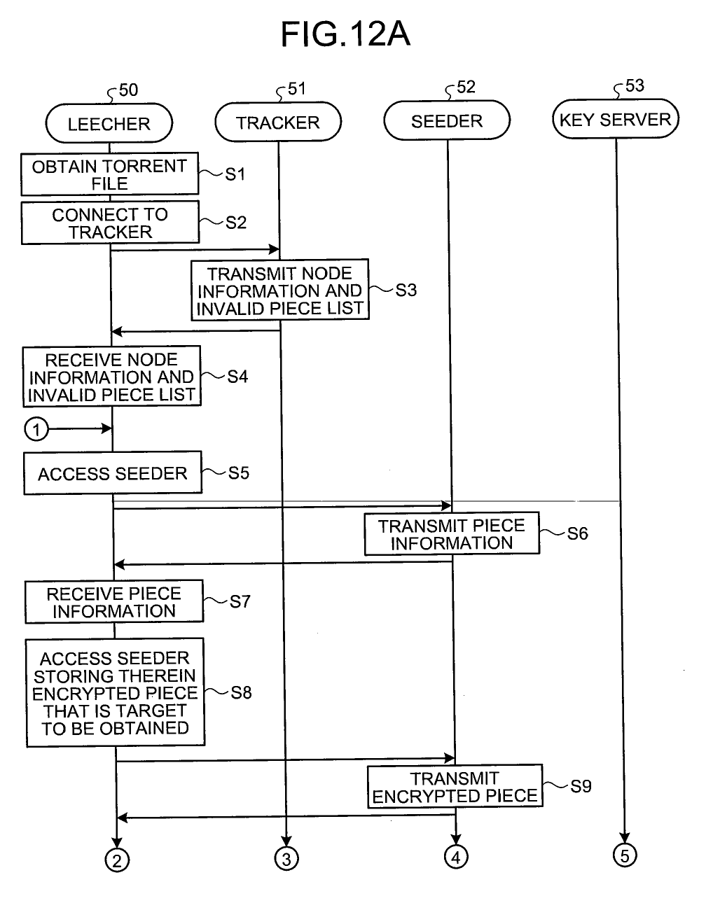

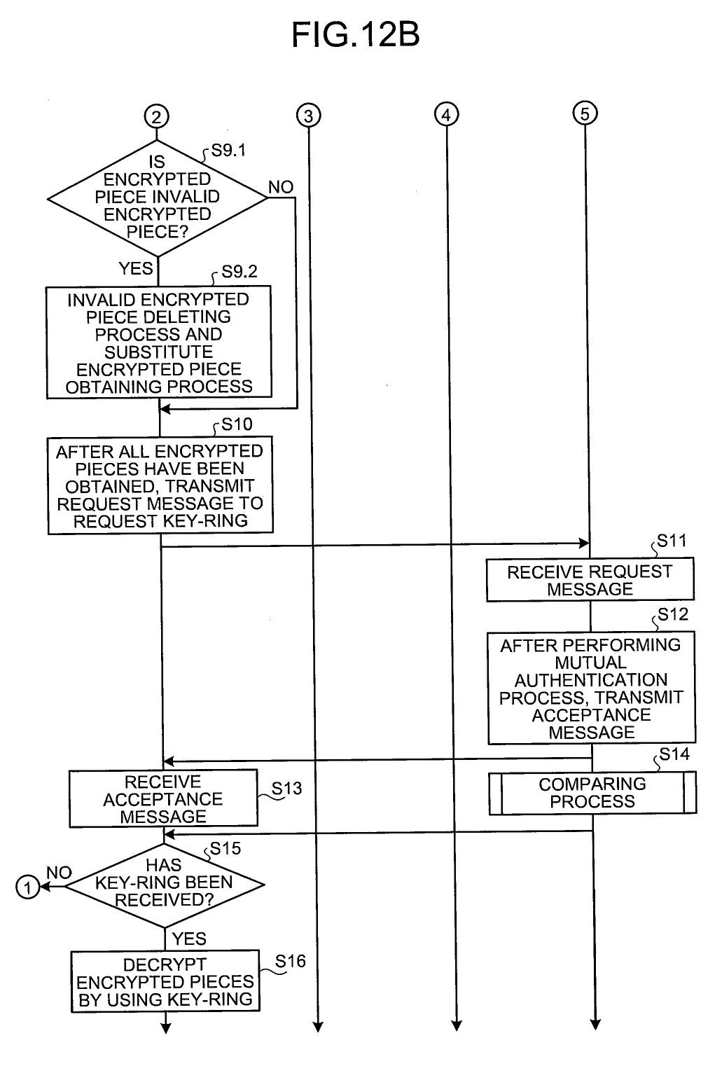

Next, a procedure in a content distributing process performed in the content distribution system according to the present embodiment will be explained, with reference to FIGS. 12A and 12B. The leecher 50 is able to receive encrypted pieces from any of the other leechers 50; in the following explanation, however, for the sake of convenience of the explanation, it is assumed that the leecher 50 receives the encrypted pieces from at least one of the seeders 52A, 52B, and 52C.

First, the leecher 50 accesses the sales server 54 and obtains the Torrent File (Step S1). After that, the leecher 50 accesses the tracker 51 by using the tracker connection destination information included in the tracker information contained in the Torrent File (Step S2). The tracker 51 then transmits the node information and the invalid piece list to the leecher 50 (Step S3). When the leecher 50 has received the node information and the invalid piece list (Step S4), the leecher 50 accesses, for example, at least one of the seeders 52A, 52B, and 52C by using the node information (Step S5). When the seeder 52 is accessed by the leecher 50, the seeder 52 transmits the piece information to the leecher 50 so as to indicate the sequence of the encrypted pieces stored therein (Step S6).

When the leecher 50 has received the piece information (Step S7), the leecher 50 accesses at least one of the seeders 52 by using the piece information (Step S8). From the seeder 52, the leecher 50 requests, for each of the pieces C1 to CN, at least one of the plurality of encrypted pieces that can possibly exist in correspondence with the piece, so that the leecher 50 is able to receive the encrypted pieces. In response to the request from the leecher 50, the seeder 52 transmits the encrypted piece stored therein to the leecher 50 (Step S9). More specifically, for example, by using the piece information that has been received by accessing the seeder 52B, the leecher 50 judges whether the seeder 52B stores therein the encrypted piece corresponding to “i1=1” among the encrypted pieces E(K(i1, 1)) [C1] (where i1 is an integer that satisfies 1≦i1≦m) obtained by encrypting the piece C1. In the case where the result of the judging process is in the affirmative, the leecher 50 accesses the seeder 52B and obtains the encrypted piece E(K(1, 1)) [C1] by receiving it from the seeder 52B. In the case where the seeder 52B actually does not store therein the encrypted piece E(K(1, 1)) [C1], the leecher 50 subsequently accesses another seeder 52 (e.g., the seeder 52C) and obtains piece information from said another seeder (e.g., the seeder 52C). In the same manner as described above, by using the piece information, the leecher 50 judges whether the seeder 52C stores therein the encrypted piece. In the case where the result of the judging process is in the affirmative, the leecher 50 accesses the seeder 52C and attempts to obtain the encrypted piece.

When having obtained the one of the encrypted pieces from the seeder 52, the content obtaining unit 500 included in the leecher 50 judges whether the encrypted piece is an invalid encrypted piece by referring to the invalid piece list obtained at Step S4 (Step S9.1). More specifically, the content obtaining unit 500 calculates a hash value of the obtained encrypted piece and judges whether the calculated hash value is listed in the invalid piece list. In the case where the calculated hash value is listed in the invalid piece list, the content obtaining unit 500 judges that the encrypted piece is an invalid encrypted piece according to the invalid piece list obtained at Step S4. In that situation (Yes at Step S9.1), the content obtaining unit 500 performs an invalid encrypted piece deleting process and a substitute encrypted piece obtaining process. More specifically, after deleting the encrypted piece obtained at Step S7, the content obtaining unit 500 requests, from the seeder 52, a substitute encrypted piece from which the same piece can be decrypted as from the deleted encrypted piece, by using a decryption key that is different from the decryption key used for decrypting the deleted encrypted piece (Step S9.2). In response to the request from the leecher 50, the seeder 52 transmits a corresponding one of the encrypted pieces stored therein, to the leecher 50. On the contrary, in the case where the content obtaining unit 500 has judged at Step S9.1 that the encrypted piece obtained from the seeder 52 is not an invalid encrypted piece (No at Step S9.1), the content obtaining unit 500 does not perform the process at Step S9.2.

By repeating the processes at Steps S8 through S9.2, the leecher 50 obtains all the encrypted pieces {E(K(i1, 1)) [C1], E(K(i2, 2)) [C2], . . . , E(K(iN, N)) [CN]} that respectively correspond to the pieces constituting the content and that constitute the encrypted content. The key-ring requesting unit 501 included in the leecher 50 transmits the request message to the key server 53 to request the key-ring containing the decryption keys used for decrypting the encrypted pieces (Step S10). The request message contains the index information {(i1, 1), (i2, 2), . . . , (iN, N)} indicating the sequence corresponding to the decryption keys.

When the authentication/key exchange processing unit 533 included in the key server 53 has received the request message via the network interface unit 532 (Step S11), the authentication/key exchange processing unit 533 performs a mutual authentication process with the leecher 50. In the case where the authentication process has been performed successfully, the authentication/key exchange processing unit 533 transmits an acceptance message to the leecher 50 to indicate that the request has been accepted (Step S12). When the leecher 50 has received the acceptance message from the key server 53 (Step S13), the leecher 50 waits for the key-ring to be transmitted from the key server 53.

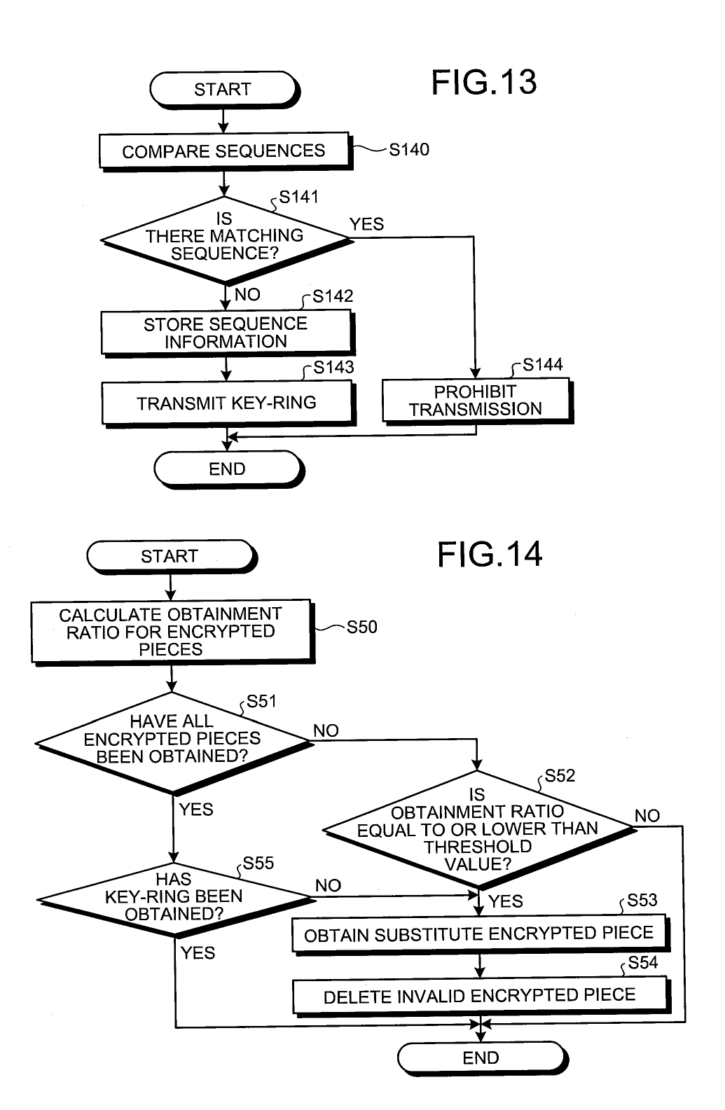

On the other hand, the sequence information comparing unit 535 included in the key server 53 performs a comparing process by using the index information contained in the request message that has been received at Step S11 (Step S14). FIG. 13 is a flowchart of a procedure in the comparing process. In the comparing process, the sequence information comparing unit 535 compares the index information contained in the request message that has been received at Step S11 with the sequence information stored in the sequence information storage unit 536 (Step S140) and judges whether the sequence information storage unit 536 stores therein sequence information indicating the same sequence as the sequence indicated in the index information (Step S141). In other words, the sequence information comparing unit 535 judges whether the key-ring requested by the leecher 50 was transmitted to any of the leechers 50 in the past.

In the case where the result of the judging process is in the negative (No at Step S141), the sequence information comparing unit 535 determines that the key-ring {K(i1, 1), K(i2, 2), . . . , K(iN, N)} corresponding to the sequence indicated in the index information should be transmitted. Thus, the sequence information comparing unit 535 instructs, via the controlling unit 530, the key supplying unit 537 to transmit the key-ring to the leecher 50. In addition, the sequence information comparing unit 535 stores sequence information indicating the sequence into the sequence information storage unit 536 (Step S142). The key supplying unit 537 reads the key-ring of which the transmission has been instructed by the sequence information comparing unit 535 via the controlling unit 530 out of the key storage unit 534 and transmits the read key-ring to the leecher 50 via the network interface unit 532 (Step S143). On the contrary, in the case where the result of the judging process at Step S141 is in the affirmative, the sequence information comparing unit 535 determines that the key-ring should not be transmitted and instructs, via the controlling unit 530, the key supplying unit 537 that the transmission of the key-ring to the leecher 50 is prohibited (Step S144).

Returning to the description of FIGS. 12A and 12B, in the case where the leecher 50 has received the key-ring {K(i1, 1), K(i2, 2), . . . , K(iN, N)} from the key server 53 (Yes at Step S15), the leecher 50 decrypts the encrypted pieces E(K(i1, 1)) [C1], E(K(i2, 2)) [C2], . . . , E(K(iN, N)) [CN] by using the decryption keys contained in the key-ring (Step S16) so as to obtain the decrypted pieces C1 to CN and obtain the content C constituted with the pieces C1 to CN. In other words, the leecher 50 decrypts E(K(i1, 1)) [C1] by using the decryption key K(i1, 1) and obtains the piece C1, decrypts E(K(i2, 2)) [C2] by using the decryption key K(i2, 2) and obtains the piece C2, and decrypts E(K(iN, N)) [CN] by using the decryption key K(iN, N) and obtains the piece CN. The leecher 50 obtains the other pieces in the same manner. Thus, the leecher 50 has obtained the content C that is constituted with the pieces C1 to CN.

On the contrary, in the case where the leecher 50 does not receive the key-ring at Step S15 and has received an error message transmitted from the key server 53 at Step S143 shown in FIG. 13, the leecher 50 is not able to decrypt the pieces that have been obtained at Step S10 and is therefore not able to use the content. In this situation, the process returns to Step S5, so that the leecher 50 obtains encrypted pieces in a sequence that is different from the sequence obtained at Step S10 and performs the processes at Step S10 and thereafter again (No at Step S15).

As explained above, in the case where the one content is distributed to the plurality of leechers 50 via the P2P network NT, the key server 53 determines whether the key-rings should be transmitted by using the sequences of the encrypted pieces. In this situation, because the key server 53 avoids re-using the sequences that have already been used, it is possible to individualize the content for each of the leechers 50. Accordingly, for example, even if one key-ring is leaked, it is possible to decrypt only the encrypted content that corresponds to the leaked key-ring. Thus, it is possible to inhibit illegitimate use of the content. In addition, by using, instead of a predetermined sequence, the sequence defined by the encrypted pieces that are arbitrarily obtained by the leecher 50, it is possible to realize a flexible content distributing process that is compliant with the environment of the P2P network NT.

In the configuration described above, of the obtained encrypted pieces, the leecher 50 deletes the one or more encrypted pieces that have each been judged to be an invalid encrypted piece based on the invalid piece list and obtains the one or more substitute encrypted pieces. With this arrangement, even if one or more of the decryption keys used for decrypting the encrypted pieces have been leaked, it is possible to specify the corresponding encrypted pieces as invalid encrypted pieces and to delete the specified encrypted pieces. Thus, it is possible to inhibit the impact of leakage of the decryption keys. In addition, by obtaining the one or more substitute encrypted pieces that serve as substitutes for the invalid encrypted pieces, it is possible to inhibit the impact on the leecher's use of the contents. Consequently, it is possible to prevent the user's convenience from being hampered.

In the embodiment described above, an arrangement is acceptable in which the various types of programs executed by the leecher 50 are stored in a computer connected to a network such as the Internet so that the programs are provided as being downloaded via the network. Another arrangement is acceptable in which the various types of programs are provided as being recorded on a computer-readable recording medium such as a CD-ROM, a flexible disk (FD), a Compact Disk Recordable (CD-R), or a Digital Versatile Disk (DVD), in a file that is in an installable format or in an executable format. The same applies to the various types of programs executed by the key server 53.

In the embodiment described above, in terms of the timing, the tracker 51 transmits the invalid piece list at the same time as transmitting the node information; however, the present invention is not limited to this example. Another arrangement is acceptable in which the tracker 51 transmits the invalid piece list at an arbitrary time.

Also, in the embodiment described above, the invalid piece list is transmitted to the leecher 50 by the tracker 51; however, the present invention is not limited to this example. It is acceptable if the invalid piece list is transmitted to the leecher 50 by a seeder 52 such as the initial seeder 52A. In that situation, an arrangement is acceptable in which the seeder 52 transmits the invalid piece list, together with the piece information, to the leecher 50 at Step S6. Another arrangement is acceptable in which the seeder 52 transmits the invalid piece list at an arbitrary time.

In the embodiment described above, after the leecher 50 has obtained one of the encrypted pieces from the seeder 52, the leecher 50 judges at Step S9.1 whether the encrypted piece is an invalid encrypted piece by referring to the invalid piece list; however, the present invention is not limited to this example. Another arrangement is acceptable in which, when the leecher 50 requests the one of the encrypted pieces from the seeder 52 at Step S8, the leecher 50 requests an encrypted piece other than the invalid encrypted pieces from the seeder 52. More specifically, the leecher 50 determines an encrypted piece that is an obtainment candidate by using the piece information obtained at Step S7, calculates a hash value of the encrypted piece, and judges whether the calculated hash value is listed in the invalid piece list obtained at Step S3. In other words, the leecher 50 judges whether the encrypted piece serving as the obtainment candidate is an invalid encrypted piece, by referring to the invalid piece list. In the case where the leecher 50 has judged that the encrypted piece is not an invalid encrypted piece, the leecher 50 accesses the seeder 52B and obtains the encrypted piece from the seeder 52B. On the other hand, in the case where the leecher 50 has judged that the obtainment candidate encrypted piece is an invalid encrypted piece, the leecher 50 further judges whether the seeder 52B stores therein an encrypted piece from which the same piece can be decrypted as from the obtainment candidate encrypted piece by using a decryption key that is different from the decryption key used for decrypting the obtainment candidate encrypted piece. According to the result of the judging process, the leecher 50 further judges whether this encrypted piece is an invalid encrypted piece. According to the result of this judging process, the leecher 50 accesses the seeder 52B and obtains the encrypted piece that is not an invalid encrypted piece and serves as a substitute.

With this arrangement also, it is possible to inhibit the impact of leakage of the decryption keys. In addition, it is possible to prevent the user's convenience from being hampered.

In the embodiment described above, in the case where it has been judged that the leecher 50 is not able to completely receive the encrypted piece transmitted at Step S9, an arrangement is acceptable in which the leecher 50 returns to one of the steps before Step S9 and starts the process all over again. It is judged that the leecher 50 is not able to completely receive the transmitted encrypted piece in the case where, for example, the leecher 50 has received an encrypted piece or a part of a specific encrypted piece, but the number of times the leecher 50 has attempted to obtain it and failed to do so has exceeded a predetermined threshold value, or the period of time that has elapsed since the start of the obtaining process has exceeded a predetermined threshold value.

In the embodiment described above, at Step S8, after the leecher 50 has judged whether the seeder 52B stores therein the desired encrypted piece by using the piece information that has been received by accessing the seeder 52B, the leecher 50 receives the encrypted piece E(K(1, 1)) [C1] from the seeder 52B. In other words, the leecher 50 judges whether the seeder 52B stores therein the encrypted piece corresponding to, for example, “i1=1” among the encrypted pieces E(K(i1, 1)) [C1] (where i1 is an integer that satisfies 1≦i1≦m) obtained by encrypting the piece C1, and in the case where the result of the judging process is in the affirmative, the leecher 50 accesses the seeder 52B and receives the encrypted piece E(K(1, 1)) [C1] from the seeder 52B. However, another arrangement is acceptable in which the leecher 50 does not specify “i1=1”, but obtains, from the seeder 52B, any one of the encrypted pieces obtained by encrypting the piece C1 with the plurality of encryption keys. In that situation, the leecher 50 judges whether the encrypted piece obtained from the seeder 52B is an invalid encrypted piece by referring to the invalid piece list. In the case where the leecher 50 has judged that the obtained encrypted piece is an invalid encrypted piece, the leecher 50 deletes the obtained encrypted piece and obtains a substitute encrypted piece from the seeder 52B.

With this arrangement also, it is possible to inhibit the impact of leakage of the decryption keys. In addition, it is possible to prevent the user's convenience from being hampered.

In the embodiment described above, during the invalid encrypted piece deleting process and the substitute encrypted piece obtaining process performed at Step S9.2, in the case where the leecher 50 has judged that the obtained encrypted piece is an invalid encrypted piece, the leecher 50 deletes the encrypted piece. However, another arrangement is acceptable in which the leecher 50 determines whether the leecher 50 should delete the encrypted piece that has been judged to be an invalid encrypted piece, based on an obtainment status of the encrypted pieces or an obtainment status of the decryption keys. FIG. 14 is a flowchart of a procedure in an invalid encrypted piece deleting process and a substitute encrypted piece obtaining process according to the present modification example. The content obtaining unit 500 included in the leecher 50 refers to the Torrent File and calculates an obtainment ratio for the encrypted pieces that have already been obtained (Step S50). For example, the obtainment ratio can be calculated in the following manner: The Torrent File indicates that the content is constituted with the pieces C1 to CN. By referring to the Torrent File, the content obtaining unit 500 is able to determine the total number of pieces that constitute the content. Thus, the content obtaining unit 500 calculates a ratio of the number of pieces that have been received as encrypted pieces among the pieces C1 to CN constituting the content to the total number of pieces C1 to CN (i.e., N in the present example), as the obtainment ratio.

Next, the content obtaining unit 500 refers to the obtainment ratio calculated at Step S50 and judges whether all the encrypted pieces corresponding to the pieces C1 to CN have been obtained (Step S51). In the case where the content obtaining unit 500 has judged that all the encrypted pieces have not been obtained (No at Step S51), the content obtaining unit 500 judges whether the obtainment ratio calculated at Step S50 is equal to or lower than a predetermined threshold value (Step S52). In the case where the obtainment ratio is not equal to or lower than the threshold value (No at Step S52), the content obtaining unit 500 does not delete the encrypted piece obtained from the seeder at Step S9.1. On the contrary, in the case where the obtainment ratio is equal to or lower than the threshold value (Yes at Step S52), the content obtaining unit 500 obtains a substitute encrypted piece from which the same piece can be decrypted as from the encrypted piece obtained from the seeder 52 at Step S9.1, by using a decryption key that is different from the decryption key used for decrypting the encrypted piece obtained at Step S9.1 (Step S53). After that, the content obtaining unit 500 deletes the encrypted piece obtained from the seeder 52 at Step S9.1 (Step S54). With this arrangement, it is possible to apply a restriction so that a substitute encrypted piece is obtained only when the obtainment ratio for the encrypted pieces is equal to or lower than the threshold value.

On the other hand, in the case where the content obtaining unit 500 has judged at Step S51 that all the encrypted pieces corresponding to the pieces C1 to CN have been obtained (Yes at Step S51), the content obtaining unit 500 judges whether the key-ring obtaining unit 502 has obtained the key-ring containing the decryption keys used for decrypting the encrypted pieces, respectively (Step S55). In the case where the content obtaining unit 500 has judged that the key-ring obtaining unit 502 has not obtained the key-ring (No at Step S55), the content obtaining unit 500 performs the processes at Step S53 and thereafter. On the contrary, in the case where the content obtaining unit 500 has judged that the key-ring obtaining unit 502 has obtained the key-ring (Yes at Step S55), the content obtaining unit 500 does not delete the encrypted piece that has been obtained from the seeder 52 at Step S9.1. With this arrangement, in the case where the key-ring has already been obtained, it is possible to avoid performing the processes of deleting the specific encrypted piece that is an invalid encrypted piece and obtaining a substitute encrypted piece, so that the user's convenience is prioritized.

In the embodiment described above, the leecher 50 obtains the encrypted pieces from the seeder 52; however, the present invention is not limited to this example. Another arrangement is acceptable in which the leecher 50 obtains the encrypted pieces from any of the other leechers 50.

Yet another arrangement is acceptable in which, with respect to each of the encrypted pieces that respectively correspond to the pieces C1 to CN, the leecher 50 obtains a plurality of mutually different encrypted pieces for the piece. For example, with respect to the piece C1, it is acceptable for the leecher 50 to obtain the encrypted pieces E(K(i1, 1)) [C1] and E(K(i1′, 1)) [C1] (where i1≠i1′, 1≦i1≦m, and 1≦i1′≦m are satisfied). With this arrangement, in the case where the leecher 50 has judged at Step S9.2 that the encrypted piece obtained at Step S9.1 is an invalid encrypted piece, after the leecher 50 has deleted the encrypted piece the leecher 50 is able to omit the substitute encrypted piece obtaining process, if the following condition is satisfied: a substitute encrypted piece that serves as a substitute for the deleted encrypted piece has already been obtained. Further, with this arrangement, when the leecher 50 requests the key-ring from the key server 53, if the sequence containing the index (i1, 1) has already been used, the leecher 50 is not able to obtain the key-ring corresponding to the sequence, but if the sequence containing the index (i1′, 1) is usable, the leecher 50 is able to obtain the key-ring corresponding to this sequence from the key server 53 without having to access the seeder 52 again. With this arrangement in which the leecher 50 obtains the extra encrypted piece in advance, the leecher 50 is able to prepare the plurality of sequence candidates in advance. Thus, the leecher 50 is able to avoid the trouble of having to access the seeder 52 again.

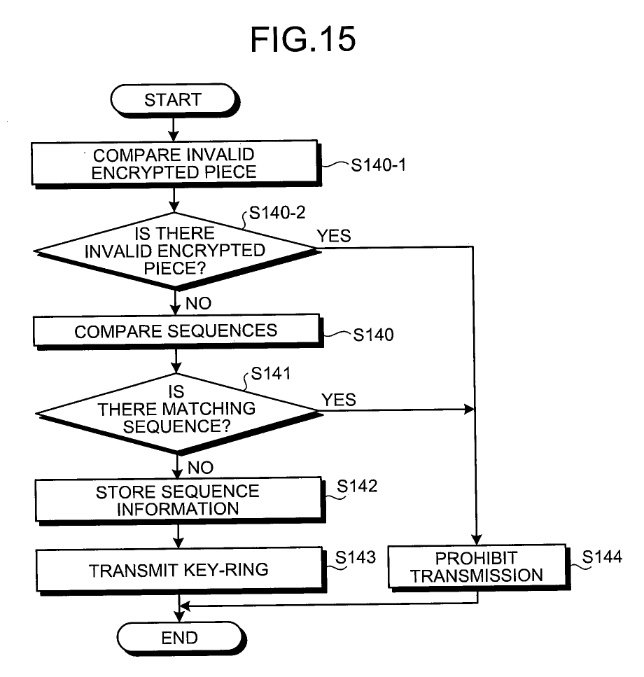

In the embodiment described above, the leecher 50 judges whether the obtained encrypted piece is an invalid encrypted piece by referring to the invalid piece list; however, the present invention is not limited to this example. Another arrangement is acceptable in which the key server 53 judges whether the encrypted piece that has been obtained by the leecher 50 is an invalid encrypted piece. More specifically, for example, during the comparing process performed at Step S140 in FIG. 13, the sequence information comparing unit 535 included in the key server 53 judges whether any of the encrypted pieces decrypted with the decryption keys contained in the key-ring requested by the leecher 50 is an invalid encrypted piece. In this situation, for example, the invalid piece list shows one or more indexes of the one or more encrypted pieces each of which is specified as an invalid encrypted piece. The sequence information comparing unit 535 included in the key server 53 obtains the invalid piece list by receiving it from the tracker 51 or the seeder 52 or by reading it from a storage medium according to an operation of a managing person. FIG. 15 is a flowchart of a procedure in the comparing process according to the present modification example. The sequence information comparing unit 535 included in the key server 53 compares the index information contained in the request message that has been received at Step S11 in FIG. 12B with the invalid piece list (Step S140-1) and judges whether any of the indexes included in the sequence indicated in the index information matches any of the indexes listed in the invalid piece list (Step S140-2). In the case where the result of the judging process is in the affirmative, it means that the encrypted pieces for which the decryption keys have been requested by the leecher 50 include one or more invalid encrypted pieces. In that situation (Yes at Step S140-2), the sequence information comparing unit 535 determines that the key-ring containing the decryption keys for the encrypted pieces should not be transmitted, and the process proceeds to Step S144. After that, in the same manner as described above, the sequence information comparing unit 535 instructs the key supplying unit 537 that the transmission of the key-ring to the leecher 50 is prohibited, the key-ring having been requested in the request message received at Step S11. On the contrary, in the case where the result of the judging process at Step S140-2 is in the negative (No at Step S140-2), that is, in the case where the encrypted pieces for which the decryption keys have been requested by the leecher 50 include no invalid encrypted piece, the sequence information comparing unit 535 performs the processes at Step S140 and thereafter in the same manner as described above so as to determine whether the key-ring should be transmitted according to the result of the sequence comparing process and to transmit the key-ring to the leecher 50 according to the result of the determining process.

With this arrangement, it is possible to inhibit the impact of leakage of the decryption keys, without increasing the processing load on the leecher 50.

In the case where the encrypted pieces for which the decryption keys have been requested by the leecher 50 include no invalid encrypted piece, another arrangement is acceptable in which the sequence information comparing unit 535 does not perform the processes at Steps S140 through S141, but instructs the key supplying unit 537 to transmit the key-ring to the leecher 50, the key-ring having been requested in the request message received at Step S11. In other words, an arrangement is acceptable in which, in the case where none of the encrypted pieces obtained by the leecher 50 is an invalid encrypted piece, the key server 53 transmits, to the leecher 50, the key-ring requested by the leecher 50 in the request message.

In the description above, in the case where it has been judged at Step S140-2 that the encrypted pieces for which the decryption keys have been requested by the leecher 50 include one or more invalid encrypted pieces, the key server 53 does not transmit the key-ring containing the decryption keys to the leecher 50; however, the present invention is not limited to this example. Another arrangement is acceptable in which the key server 53 transmits, to the leecher 50, a substitute encrypted piece (hereinafter, a “valid encrypted piece”) that serves as a substitute for the invalid encrypted piece and a key-ring containing the decryption key for decrypting the valid encrypted piece. In that situation, it is assumed that, like the initial seeder 52A, the key server 53 stores therein, for each of the encrypted pieces that respectively correspond to the pieces constituting the content, all of the encrypted pieces that have been generated by encrypting the piece by using a plurality of encryption keys per piece. In the case where the result of the judging process performed at Step S140-2 is in the affirmative, the key server 53 generates another sequence {(i1′, 1), (i2, 2), . . . , (iN, N)} that contains no indexes of the invalid encrypted pieces and that has not been stored in the sequence information storage unit 536. In other words, the key server 53 determines the decryption key used for decrypting the substitute encrypted piece from which the same piece can be decrypted as from the invalid encrypted piece, by using a decryption key that is different from the decryption key used for decrypting the invalid encrypted piece. The key server 53 further determines the sequence that shows a combination of indexes including the index of the determined decryption key and that has not been stored in the sequence information storage unit 536. Subsequently, the key server 53 transmits the index (i.e., (i1′, 1) in the present example) to the leecher 50, as replacement index information, together with the valid encrypted piece (e.g., E(K(i1′, 1)) [C1]). In addition, the key server 53 transmits a key-ring containing the decryption keys that correspond to the sequence {(i1′, 1), (i2, 2), . . . , (iN, N)} to the leecher 50.

With this arrangement, it is possible to inhibit the impact of leakage of the decryption keys, without increasing the processing load on the leecher 50. Further, because the key server 53 transmits, to the leecher 50, the valid encrypted piece and the key-ring containing the decryption key used for decrypting the valid encrypted piece, the leecher 50 is able to avoid the trouble of having to access the seeder 52 and the key server 53 again.

The indexes indicated in the replacement index information are not limited to the example described above, as long as the replacement index information is able to specify the decryption key used for decrypting the substitute encrypted piece from which the same piece can be decrypted as from the encrypted piece specified as an invalid encrypted piece in the invalid piece list, by using a decryption key that is different from the decryption key used for decrypting the encrypted piece specified as an invalid encrypted piece.

In the embodiment described above, the leecher 50 judges whether the obtained encrypted piece is an invalid encrypted piece, by referring to the invalid piece list; however, the present invention is not limited to this example. Another arrangement is acceptable in which the seeder 52 refers to the invalid piece list and does not transmit, to the leecher 50, any of the encrypted pieces each of which is an invalid encrypted piece. With this arrangement, it is possible to inhibit the impact of leakage of the decryption keys, without increasing the processing load on the leecher 50.

In the embodiment described above, in the case where the leecher 50 has judged that the encrypted piece obtained from the seeder 52 is an invalid encrypted piece, after the leecher 50 has deleted the encrypted piece, the leecher 50 obtains the substitute encrypted piece; however, another arrangement is acceptable in which the leecher 50 does not obtain the substitute encrypted piece. With this arrangement, in the case where there is an invalid encrypted piece with respect to at least one of the pieces that constitute the content, it is possible to inhibit the use of the content itself. Thus, it is possible to inhibit the impact of leakage of the decryption keys more effectively.

In the embodiment described above, with regard to the encrypted pieces shown in FIG. 4, of the N pieces, each of as many pieces as “a” (where 1<a<N) is encrypted by using the plurality of mutually different encryption keys per piece. However, another arrangement is acceptable in which each of the pieces is encrypted by using only one encryption key per piece. In other words, another arrangement is acceptable in which there is only one encrypted piece for each of the pieces.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication apparatus comprising:
a receiving unit that receives, from at least another communication apparatus, a plurality of encrypted pieces obtained by encrypting a plurality of pieces that constitute a part of a content by using mutually different encryption keys; a memory to store the encrypted pieces received by the receiving unit, with corresponding identifiers;
a key obtaining unit that obtains a part or all of decryption keys used for decrypting the encrypted pieces;
a list obtaining unit that obtains an invalid piece list showing one or more identifiers of one or more encrypted pieces that have already been invalidated; and
a deleting unit that deletes at least one of the encrypted pieces from the memory according to an obtainment status of the encrypted pieces or an obtainment status of the decryption keys, when the at least one of the encrypted pieces is listed in the invalid piece list.

2. The apparatus according to claim 1, wherein the deleting unit deletes the at least one of the encrypted pieces from the memory, when at least one of the encrypted pieces is listed in the invalid piece list.

3. The apparatus according to claim 1, wherein the deleting unit includes
a determining unit that determines whether at least one of the encrypted pieces is deleted, according to a ratio of pieces received as the encrypted pieces to the plurality of pieces, when the at least one of the encrypted pieces is listed in the invalid piece list, and
a piece deleting unit that deletes at least one of the encrypted pieces from the memory according to a result of determination of the determining unit.

4. The apparatus according to claim 1, wherein the deleting unit includes
a determining unit that determines whether at least one of the encrypted pieces is deleted when the at least one of the encrypted pieces is listed in the invalid piece list, according to whether a part or all of the decryption keys are obtained; and
a piece deleting unit that deletes the at least one of the encrypted pieces from the memory according to a result of determination of the determining unit.

5. The apparatus according to claim 1, wherein the content receiving unit receives, from at least another communication apparatus, an encrypted piece from which a same piece can be decrypted as from the at least one of the encrypted pieces, by using a decryption key different from the decryption key used for decrypting the at least one of the encrypted pieces, when the at least one of the encrypted pieces is deleted from the memory.

6. The apparatus according to claim 1, wherein the list obtaining unit obtains the invalid piece list by receiving the invalid piece list from at least one of the at least another communication apparatus and a management server, the management server storing connection destination information used for accessing the at least another communication apparatus and transmitting the connection destination information to the communication apparatus.

7. The apparatus according to claim 1, wherein the list obtaining unit obtains the invalid piece list showing one or more hash values calculated by using the one or more encrypted pieces that have already been invalidated, and
the apparatus further comprises:
a calculating unit that calculates a hash value by using each of the received encrypted pieces; and
a judging unit that judges whether any of the received encrypted pieces corresponds to the one or more encrypted pieces that can respectively be decrypted by using the one or more decryption keys that have already been invalidated, according to whether any of the calculated hash values is listed in the invalid piece list.

8. The apparatus according to claim 1, further comprising a transmitting unit that transmits a request message for requesting the decryption keys used for decrypting the encrypted pieces to a key server storing the decryption keys, wherein
the key obtaining unit receives, from the key server, a part or all of the decryption keys determined by the key server to be transmitted to the communication apparatus in response to the request message.

9. A communication apparatus comprising:
a receiving unit that receives, from at least another communication apparatus, a plurality of encrypted pieces obtained by encrypting a plurality of pieces that constitute a part of a content by using mutually different encryption keys;
a key obtaining unit that obtains a part or all of the decryption keys used for decrypting the encrypted pieces; and
a list obtaining unit that obtains an invalid piece list showing one or more identifiers of one or more encrypted pieces that have already been invalidated, wherein
the receiving unit requests an encrypted piece that is not listed in the invalid piece list from the at least another communication apparatus and receives the requested encrypted piece from the at least another communication apparatus.

10. A server comprising:
a receiving unit that receives a request message for requesting decryption keys used for decrypting a plurality of encrypted pieces from a communication apparatus that receives the encrypted pieces from at least another communication apparatus, the encrypted pieces being obtained by encrypting a plurality of pieces that constitute a part of a content by using mutually different encryption keys;
a first storage unit that stores the decryption keys;
a list obtaining unit that obtains an invalid piece list showing one or more identifiers of one or more encrypted pieces that have already been invalidated;
a determining unit that determines whether the decryption keys are transmitted, according to whether any of the encrypted pieces that can respectively be decrypted by using the decryption keys requested in the request message is listed in the invalid piece list; and
a key transmitting unit that reads the decryption keys requested in the request message from the first storage unit and transmits the read decryption keys to the communication apparatus, when the determining unit has determined that the decryption keys are transmitted.

11. The server according to claim 10, further comprising a replacement determining unit that determines a decryption key used for decrypting an encrypted piece from which a same piece can be decrypted as from the encrypted piece listed in the invalid piece list, by using a decryption key different from the decryption key used for decrypting the encrypted piece listed in the invalid piece list, when the determining unit has determined that the decryption keys is not transmitted, wherein
the key transmitting unit transmits, to the communication apparatus, replacement index information specifying the decryption key that has been determined by the replacement determining unit, when the determining unit has determined that the decryption keys is not transmitted.

12. The server according to claim 11, further comprising a second storage unit that stores the encrypted pieces, wherein
the key transmitting unit transmits, to the communication apparatus, one of the encrypted pieces together with the replacement index information, when the determining unit has determined that the decryption keys is not transmitted, the encrypted pieces being stored in the second storage unit from which a same piece can be decrypted as from the encrypted piece listed in the invalid piece list, by using a decryption key different from the decryption key used for decrypting the encrypted piece listed in the invalid piece list.

13. The server according to claim 10, wherein the determining unit determines whether the decryption keys are transmitted, based on a combination of the decryption keys requested in the request message.

14. A computer program product having a computer readable medium including programmed instructions, wherein the instructions, when executed by a computer, cause the computer to perform:
receiving, from at least another communication apparatus, a plurality of encrypted pieces obtained by encrypting a plurality of pieces that constitute a part of a content by using mutually different encryption keys;
storing the encrypted pieces received by the receiving unit, with corresponding identifiers;
obtaining a part or all of decryption keys used for decrypting the encrypted pieces;
obtaining an invalid piece list showing one or more identifiers of one or more encrypted pieces that have already been invalidated; and
deleting at least one of the encrypted pieces from the memory according to an obtainment status of the encrypted pieces or an obtainment status of the decryption keys, when the at least one of the encrypted pieces is listed in the invalid piece list.

15. A computer program product having a computer readable medium including programmed instructions, wherein the instructions, when executed by a computer, cause the computer to perform:
receiving a request message for requesting decryption keys used for decrypting a plurality of encrypted pieces from a communication apparatus that receives the encrypted pieces from at least another communication apparatus, the encrypted pieces being obtained by encrypting a plurality of pieces that constitute a part of a content by using mutually different encryption keys;
obtaining an invalid piece list showing one or more identifiers of one or more encrypted pieces that have already been invalidated;
determining whether the decryption keys are transmitted, according to whether any of the encrypted pieces that can respectively be decrypted by using the decryption keys requested in the request message is listed in the invalid piece list; and
reading the decryption keys requested in the request message from a storage unit, when it has been determined that the decryption keys are transmitted, and transmitting the read decryption keys to the communication apparatus.
